(19) United States
(12) Patent Application Publication
(10) Pub. No.: US 2024/0138366 A1
(43) Pub. Date: May 2, 2024

(54) APPARATUS FOR MONITORING EXPERIMENTAL ANIMALS USING ARTIFICIAL INTELLIGENCE

(71) Applicants: Shih-Siou Wang, Taichung City (TW); Wen-Ai Wu, Taichung City (TW)

(72) Inventors: Shih-Siou Wang, Taichung City (TW); Wen-Ai Wu, Taichung City (TW)

(73) Assignee: TANGENE INCORPORATED, Taichung City (TW)

(21) Appl. No.: 17/965,851

(22) Filed: Nov. 2, 2022

(51) Int. Cl. A01K 1/03

(52) U.S. Cl. CPC A01K 1/031

(57) ABSTRACT

An apparatus for monitoring experimental animals is provided in a rack including cages each for confining an experimental animal. The apparatus includes at least one rail unit including a rail group having a first rail disposed at one side of the cage; at least one drive unit electrically connected to the at least one rail unit and including a drive disposed at one side of the first rail and operatively connected thereto so that the drive is configured to activate the first rail; at least one control unit including a controller disposed at the other side of the first rail, a first mounting board disposed on a bottom of the controller, and a second mounting board secured to the first mounting board and disposed on the first rail; and at least one sensor unit including a sensor secured to the controller and electrically connected thereto.

### FIELD OF THE INVENTION

The invention relates to apparatuses for monitoring experimental animals and more particularly to an apparatus for monitoring experimental animals using artificial intelligence.

### BACKGROUND OF THE INVENTION

A typical establishment for housing and feeding experimental animals has the following drawbacks:

Employees do manual labor to take care of experimental animals and the care is poor. An employee may go through the establishment to monitor the experimental animals confined in the cages in the morning and the afternoon every day. The monitoring includes counting the number of the experimental animals. checking whether the experimental animals are hurt or even dead, and checking whether the living environment of the experimental animals is acceptable. However, the method of monitoring experimental animals cage by cage by going through the establishment is time consuming. Further, the possibility of finding any irregularities is low due to the great number of the cages. It is often that the employee cannot find experimental animals in trouble immediately. Hence, the experimental animal right is not well protected especially in case of emergency.

Pollution control and illumination of cages. An employee is required to wear a protective gown prior to entering the establishment because pollution may be generated by experimental animals confined in the cage. Further, a long time monitoring of the confined experimental animals is impossible. Data about the experimental animals is thus insufficient. Another factor to be considered is that lights in the cage are set to turn on for first 12 hours and turn off for second 12 hours alternately per day. With respect to nighttime checking, the employee is required to use special equipment prior to entering the establishment for the sake of preventing the experimental animals from being bothered. This is why it is very difficult of monitoring the experimental animals in night time. Thus, data of experimental animals' behavior in the night is rare.

There is no standard operation procedure (SOP). Different employees may have different monitoring results of the confined experimental animals because the monitoring is done by manual labor. Regarding cage changes, it is typical of changing all dirty cages with clean ones in the same room. However, experimental animals are afraid of being bothered due to nature. Thus, a minimum number of cage changes as well as giving a well living space to the experimental animals are desired.

### SUMMARY OF THE INVENTION

It is therefore one object of the invention to provide an apparatus for monitoring experimental animals provided in a rack including a plurality of cages each for confining an experimental animal, the apparatus comprising at least one rail unit, the at least one rail unit including a rail group having a first rail disposed at one side of the cage; at least one drive unit, the at least one drive unit electrically connected to the at least one rail unit and including a drive disposed at one side of the first rail and operatively connected thereto so that the drive is configured to activate the first rail; at least one control unit, the at least one control unit including a controller disposed at the other side of the first rail, a first mounting board disposed on a bottom of the controller, and a second mounting board secured to the first mounting board and disposed on the first rail; and at least one sensor unit, the at least one sensor unit including a sensor secured to the controller and electrically connected thereto.

The invention has the following advantages and benefits in comparison with the conventional art: The first rail can move leftward and rightward (or upward and downward) alternately so that the sensor on the controller mounted on the first rail can continuously monitor the experimental animals confined in the cages for a long period of time. Thus, SOP can be followed. Only cage changes are required with bothering to the experimental animals being a minimum. Care is thus optimized. There is no need for an employee to go through the establishment to monitor the experimental animals confined in the cages. Pollution control of the cages is enhanced. The possibility of finding any irregularities is greatly increased. As a result, purposes of automatic monitoring and taking good care of experimental animals are obtained.

The above and other objects, features and advantages of the invention will become apparent from the following detailed description taken with the accompanying drawings

### BRIEF DESCRIPTION OF THE DRAWINGS

FIG. 1 is a perspective view of an apparatus for monitoring experimental animals using artificial intelligence according to a first preferred embodiment of the invention;

FIG. 2 is a detailed view of a right bottom corner of FIG. 1;

FIG. 3 schematically depicts how to mount the controller on the first rail;

FIG. 4 schematically depicts how to assemble the sensor and the controller;

FIG. 5 is a perspective view of the assembled sensor and the controller;

FIG. 6 schematically depicts the controllers moving leftward and rightward alternately along the first rails;

FIG. 7 schematically depicts the controllers moving upward and downward alternately along the first rails;

FIG. 8 is a perspective view of an apparatus for monitoring experimental animals using artificial intelligence according to a second preferred embodiment of the invention;

FIG. 9 schematically depicts the first rail of FIG. 8 moving upward and downward alternately;

FIG. 10 schematically depicts the first rail of FIG. 8 moving leftward and rightward alternately;

FIG. 11 schematically depicts the controllers of FIG. 8 moving leftward and rightward alternately along the first rail and the first rail of FIG. 8 moving upward and downward alternately along the second rails;

FIG. 12 schematically depicts how to mount a controller on a first rail according to a third preferred embodiment of the invention;

FIG. 13 schematically depicts how to mount a controller on a first rail according to a fourth preferred embodiment of the invention; and

FIG. 14 schematically depicts how to mount a controller on a first rail according to a fifth preferred embodiment of the invention.

### DETAILED DESCRIPTION OF THE INVENTION

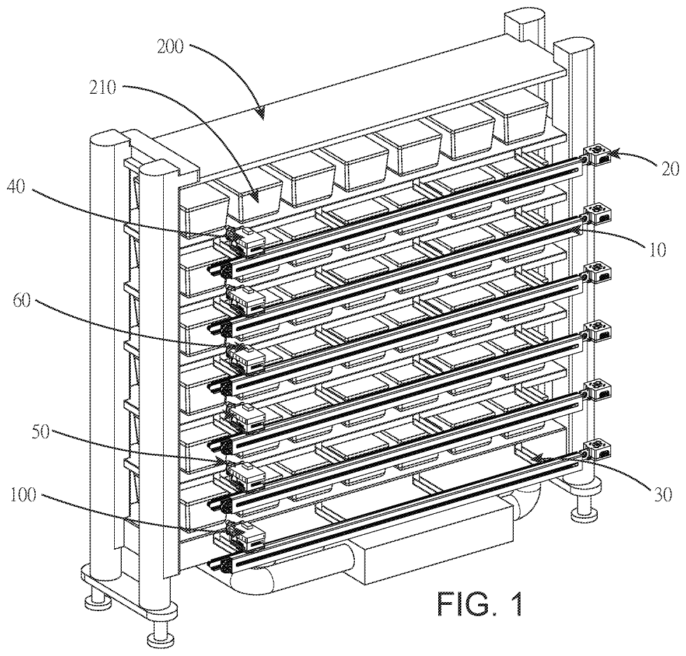

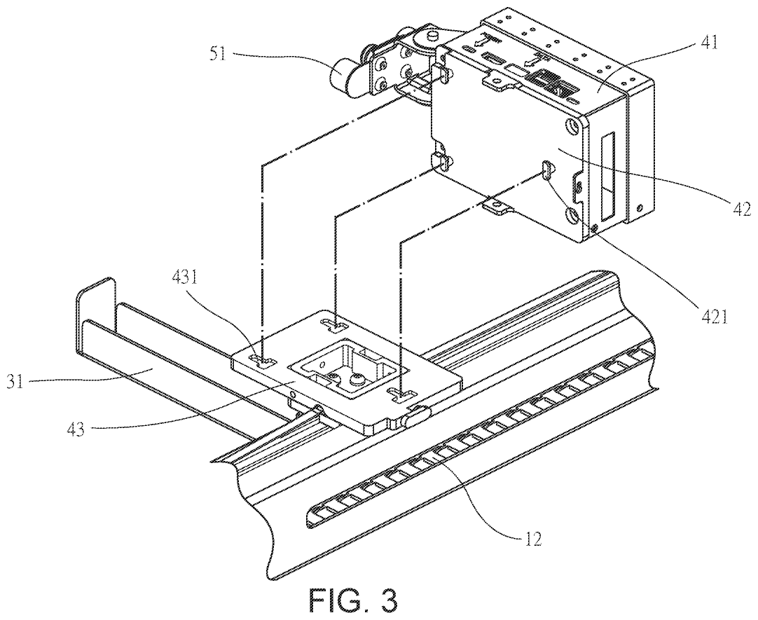

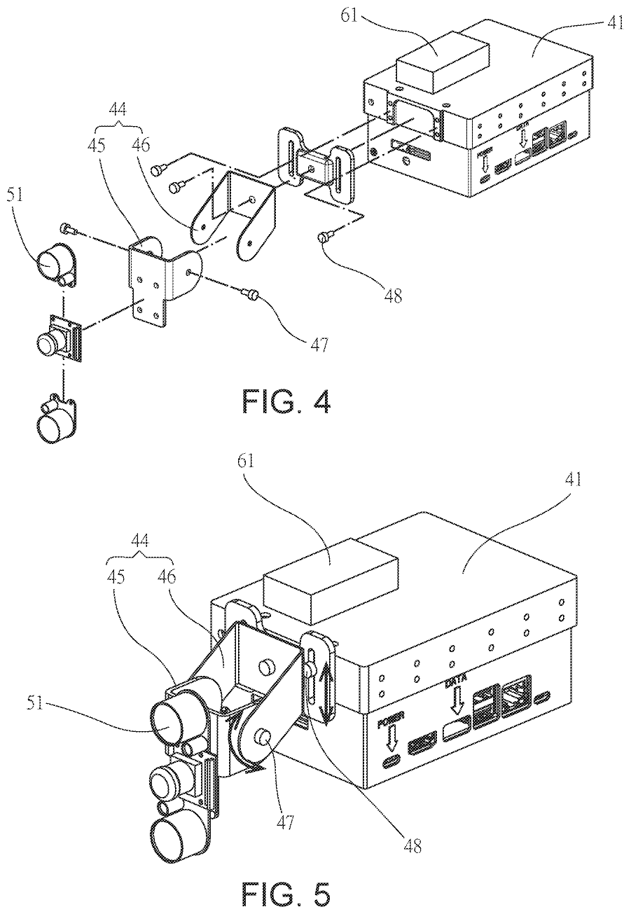

Referring to FIGS. 1 to 5, an apparatus 100 for monitoring experimental animals using artificial intelligence in accordance with a first preferred embodiment of the invention is provided in a rack 200 including a plurality of cages 210 each for confining an experimental animal. The apparatus 100 comprises the following components as discussed in detail below.

A plurality of rail units 10 are provided. Each rail unit 10 includes a rail group 11 having a first rail 12 disposed at one side of the cage 210. The first rail 12 is disposed either transversely (as shown) or longitudinally.

A plurality of drive units 20 are provided, Each drive unit 20 is electrically connected to the rail unit 10 and includes a drive 21 disposed at one side of the first rail 12 and operatively connected thereto so that the drive 21 can activate the first rail 12. In the embodiment, the drive 21 is an electric motor or a pneumatic cylinder.

A support unit 30 includes a plurality of supports 31 each for supporting the first rail 12. One end of the support 31 is secured to the rack 200 and the other end thereof is secured to the first rail 12.

A plurality of control units 40 are provided. Each control unit 40 includes a controller 41 disposed at the other side of the first rail 12. The controller 41 is an edge computing controller including a central processing unit (CPU), a memory, a graphics processing unit (GPU), a peripheral input/output (I/O) interface, a wireless transmission unit, and a data storage unit. A first mounting board 42 is provided on a bottom of the controller 41. A second mounting board 43 is provided on the first rail 12. In the embodiment, the first mounting board 42 includes a plurality of legs 421 on a bottom. The second mounting board 43 includes a plurality of cavities 431 for fastening the legs 421 therein respectively. The controller 41 is mounted on the first rail 12 and configured to slide thereon. A rear end of the controller 41 is secured to an adjustment member 44 including a first bifurcation 45, a second bifurcation 46, two first fasteners (e.g., pivot joints) 47 for pivotably securing the first bifurcation 45 and the second bifurcation 46 together, and a plurality of second fasteners 48 for moveably securing the second bifurcation 46 to the controller 41. A user may loosen the first fasteners 47 prior to pivoting the second bifurcation 45 with respect to the second bifurcation 46 about the first fasteners 47. Also, the user may loosen second fasteners 48 prior to vertically moving the second bifurcation 46 with respect to the controller 41.

A plurality of sensor units 50 are provided. Each sensor unit 50 includes a sensor 51 such as a camera, an infrared monitor, a thermometer, a hygrometer, a microphone, a vibration meter, a pressure gauge, or any combination thereof. The sensor 51 is secured to the first bifurcation 45 and electrically connected to the controller 41.

A plurality of power supplies 60 are provided. Each power supply 60 includes a power supply module 61 for supplying electricity to both the controller 41 and the sensor 51.

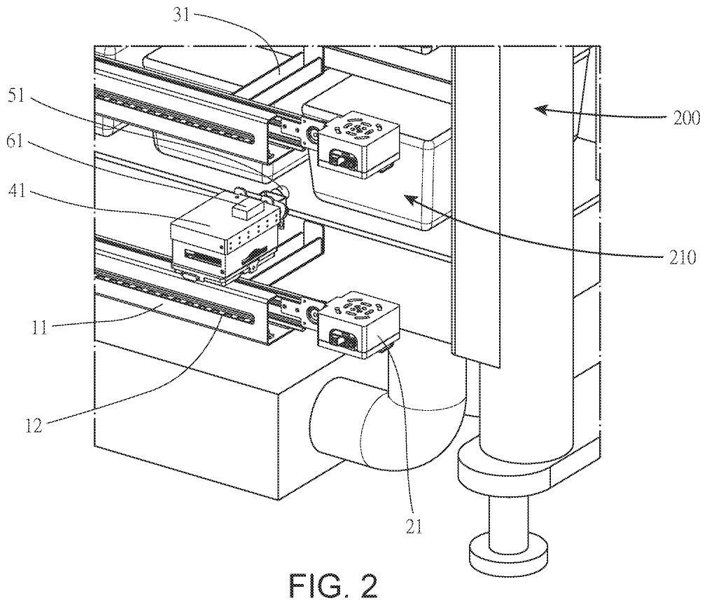

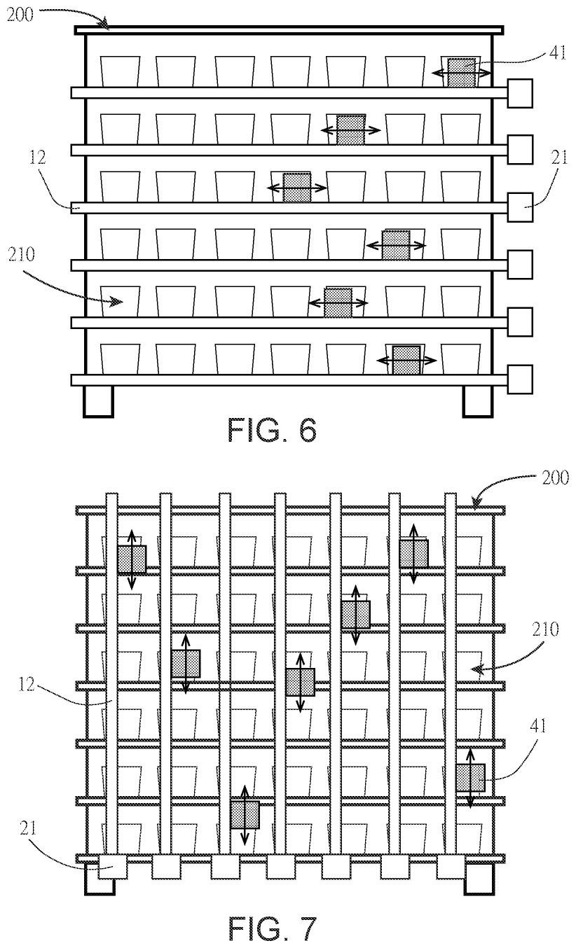

Referring to FIGS. 6 to 7 in conjunction with FIG. 2, the drive 21 is activated to move the first rail 12 transversely or longitudinally. And in turn, the first rail 12 moves the controller 41 along the first rail 12 transversely or longitudinally. Each sensor 51 associated with the corresponding controller 41 may continuously monitor an experimental animal confined in the cage 210.

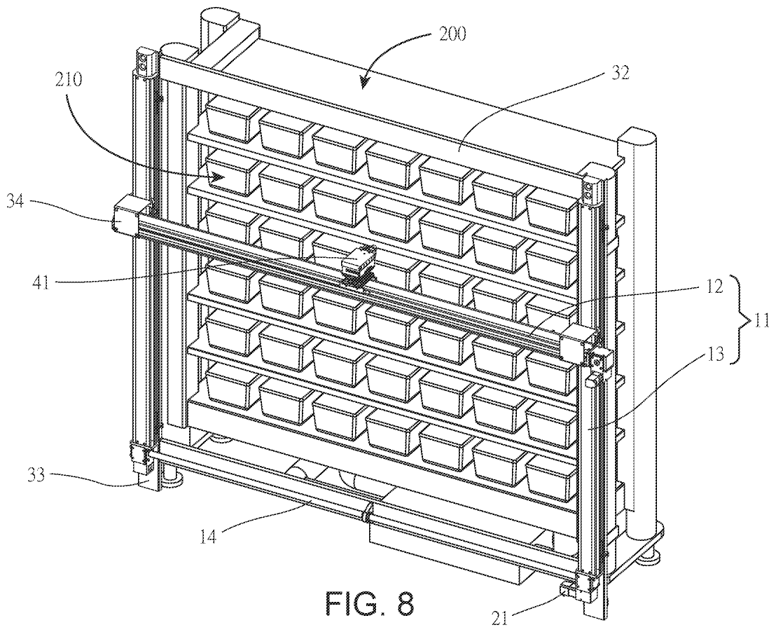

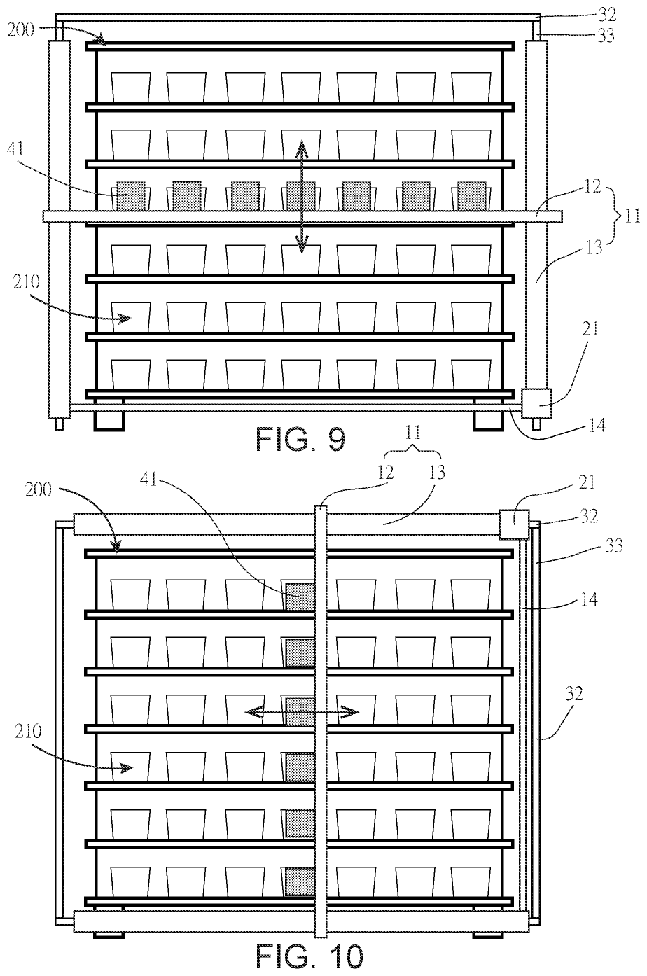

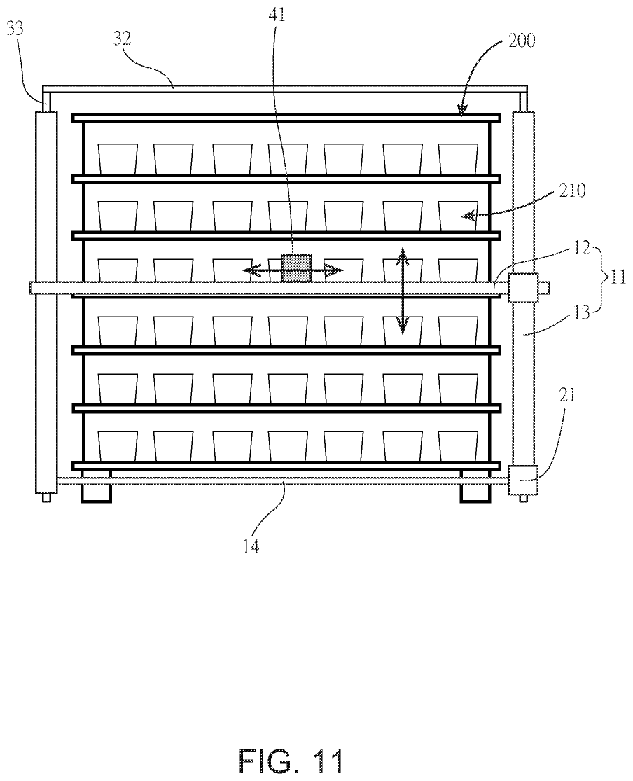

Referring to FIGS. 8 to 11, an apparatus for monitoring experimental animals using artificial intelligence in accordance with a second preferred embodiment of the invention is shown. The characteristics of the second preferred embodiment are substantially the same as that of the first preferred embodiment except the following:

The support unit 30 further comprises an inverted-U shaped or rectangular frame 32 mounted on a front portion of the rack 200 as shown (or another portion of the rack 200 in other embodiments). The frame 32 includes a plurality of support rods 33. In addition to the first rail 12, the rail group 11 further comprises two second rails 13 mounted on two sides of the frame 32 (i.e., secured to the support rods 33) respectively, and a transverse linkage 14 having a disc-shaped cross section. The drive 21 is mounted on a lower portion of one second rail 13. Two mounting members 34 are provided in which the first rail 12 and one second rail 13 are secured together by one mounting member 34, and the first rail 12 and the other second rail 13 are secured together by the other mounting member 34. Two ends of the transverse linkage 14 are secured to bottoms of the second rails 13 respectively. The drive 21 can move one second rail 13 upward and downward alternately. And in turn, the second rail 13 rotates the transverse linkage 14 which further in turn moves the other second rail 13 upward and downward alternately. As such, the first rail 12 moves leftward and rightward alternately, the first rail 12 also moves upward and downward alternately along the second rails 13, and the controller 41 moves leftward and right alternately along the first rail 12. In addition, another drive 21 can be provided on the first rail 12 for moving the first rail 12 leftward and rightward alternately. Also, the controller 41 moves leftward and rightward alternately along the first rail 12. This can increases convenience of using the invention.

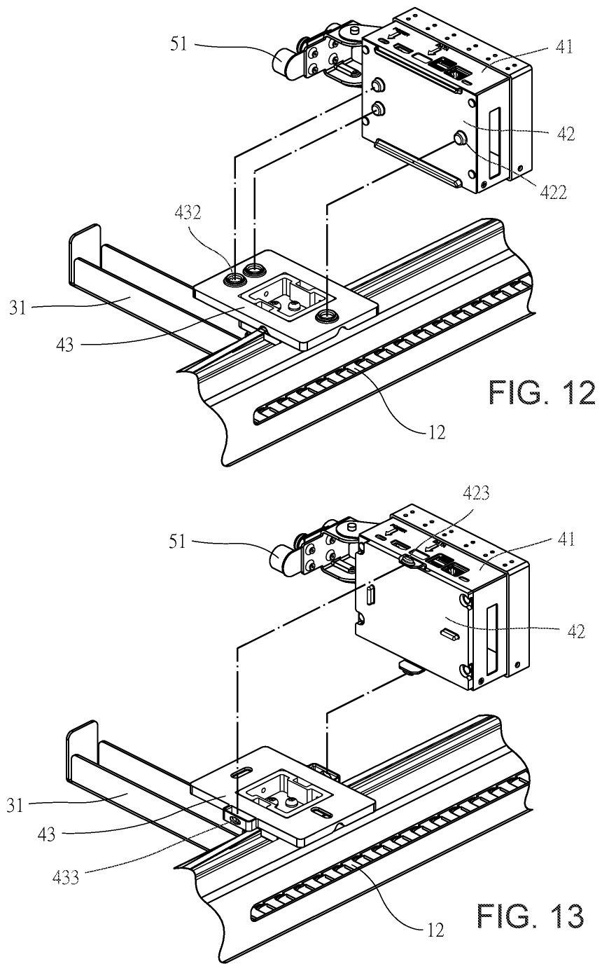

Referring to FIG. 12, an apparatus for monitoring experimental animals using artificial intelligence in accordance with a third preferred embodiment of the invention is shown. The characteristics of the third preferred embodiment are substantially the same as that of the first preferred embodiment except the following:

A plurality of projecting magnets 422 are provided on a bottom of the first mounting board 42 and a plurality of steel holes 432 are provided on a top of the second mounting board 43. The steel holes 432 attract the magnets 422 disposed therein respectively. As a result, the controller 41 is moveably mounted on the first rail 12.

Referring to FIG. 13, an apparatus for monitoring experimental animals using artificial intelligence in accordance with a fourth preferred embodiment of the invention is shown. The characteristics of the fourth preferred embodiment are substantially the same as that of the first preferred embodiment except the following:

Two latches 423 are provided on two sides of the first mounting board 42 respectively, and two receptacles 433 are provided on two sides of the second mounting board 43 respectively. The latches 423 can be disposed in the receptacles 433 by pressing respectively. As a result, the controller 41 is moveably mounted on the first rail 12.

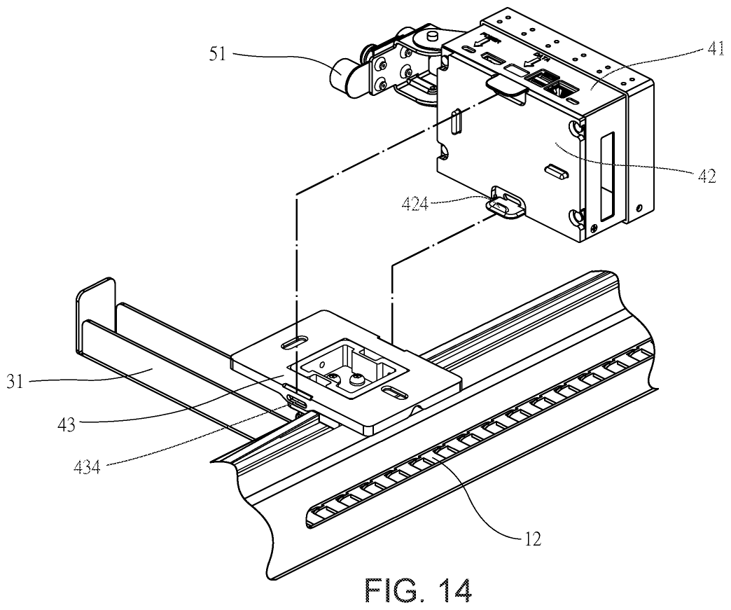

Referring to FIG. 14, an apparatus for monitoring experimental animals using artificial intelligence in accordance with a fifth preferred embodiment of the invention is shown. The characteristics of the fifth preferred embodiment are substantially the same as that of the first preferred embodiment except the following:

Two latches 424 are provided on two sides of the first mounting board 42 respectively, and two holes 434 are provided on two sides of the second mounting board 43 respectively. The latches 424 can be disposed in the holes 433 by pressing respectively. As a result, the controller 41 is moveably mounted on the first rail 12.

While the invention has been described in terms of preferred embodiments, those skilled in the art will recognize that the invention can be practiced with modifications within the spirit and scope of the appended claims.

What is claimed is:

1. An apparatus for monitoring experimental animals disposed in a rack including a plurality of cages each for confining an experimental animal; the apparatus comprising:
at least one rail unit, the at least one rail unit including a rail group having a first rail disposed at one side of the cage;
at least one drive unit, the at least one drive unit electrically connected to the at least one rail unit and including a drive disposed at one side of the first rail and operatively connected thereto so that the drive is configured to activate the first rail;
at least one control unit, the at least one control unit including a controller disposed at the other side of the first rail, a first mounting board disposed on a bottom of the controller, and a second mounting board secured to the first mounting board and disposed on the first rail; and
at least one sensor unit, the at least one sensor unit including a sensor secured to the controller and electrically connected thereto.

2. The apparatus of claim 1, wherein the controller is an edge computing controller including a central processing unit (CPU), a memory, a graphics processing unit (GPU), a peripheral input/output (I/O) interface, a wireless transmission unit, and a data storage unit; and the sensor is a camera, an infrared monitor, a thermometer, a hygrometer, a microphone, a vibration meter, a pressure gauge, or any combination thereof.

3. The apparatus of claim 1, further comprising an adjustment member secured to an end of the controller, the adjustment member including a first bifurcation, a second bifurcation, two first fasteners for pivotably securing the first bifurcation and the second bifurcation together, and a plurality of second fasteners for moveably securing the second bifurcation to the controller.

4. The apparatus of claim 1, wherein the first rail is disposed transversely or longitudinally.

5. The apparatus of claim 1, further comprising a support unit including a plurality of supports each for supporting the first rail, one end of the support being secured to the rack and the other end thereof being secured to the first rail; and an inverted-U shaped or rectangular frame disposed on a front portion of the rack, the frame including a plurality of support rods.

6. The apparatus of claim 5, wherein the rail group further comprises two second rails mounted on two sides of the frame and secured to the support rods respectively, and a transverse linkage having two ends secured to the second rails respectively; and wherein the drive is mounted on one of the second rails, and the first rail is secured to each of the second rail by two mounting members.

7. The apparatus of claim 1, further comprising a plurality of power supplies, each power supply including a power supply module for supplying electricity to both the controller and the sensor.

8. The apparatus of claim 1, wherein the first mounting board includes a plurality of legs on a bottom; the second mounting board includes a plurality of cavities for fastening the legs therein respectively; and the controller is mounted on the first rail and configured to slide thereon.

9. The apparatus of claim 1, further comprising a plurality of magnets disposed on a bottom of the first mounting board and a plurality of steel holes disposed on a top of the second mounting board, wherein the steel holes are configured to attract the magnets disposed therein respectively so as to moveably mount the controller on the first rail.

10. The apparatus of claim 1, further comprising two latches disposed on two sides of the first mounting board respectively and two receptacles disposed on two sides of the second mounting board respectively, wherein the latches are configured to dispose in the receptacles respectively so as to moveably mount the controller on the first rail.

11. The apparatus of claim 1, further comprising two latches disposed on two sides of the first mounting board respectively and two holes disposed on two sides of the second mounting board respectively, wherein the latches are configured to dispose in the holes respectively so as to moveably mount the controller on the first rail.
